(19) United States
(12) Patent Application Publication
(10) Pub. No.: US 2011/0198102 A1
(43) Pub. Date: Aug. 18, 2011

(54) Attachment for a Portable Power Tool

(75) Inventor: Juergen Gairing, Stuttgart (DE)

(73) Assignee: Robert Bosch GmbH, Stuttgart (DE)

(21) Appl. No.: 13/027,749

(22) Filed: Feb. 15, 2011

(30) Foreign Application Priority Data
Feb. 17, 2010 (DE) 10 2010 002 013.3

(51) Int. Cl. B25F 3/00

(52) U.S. Cl. 173/29; 279/143

(57) ABSTRACT

An attachment for a portable power tool includes an output shaft having a tool receptacle for accommodating an application tool, a locking unit which can be releasably attached to a housing of the portable power tool, and an input shaft which can be connected to a drive shaft of the portable power tool in a rotationally fixed manner. The attachment has a torque converter for converting a first torque which acts on the input shaft into a second torque which acts on the output shaft.

This application claims priority under 35 U.S.C. §119 to German patent application no. 10 2010 002 013.3, filed Feb. 17, 2010, the disclosure of which is incorporated herein by reference in its entirety.

The present disclosure relates to an attachment for a portable power tool and to a portable power tool having an attachment.

### BACKGROUND

In order to extend the possible applications for a portable power tool, such as for example a screwdriver or drill driver, an attachment can be releasably attached to the portable power tool. Different types of fastening are known for releasably attaching the attachment to the housing of the portable power tool. For example, attachments can be clamped in place on a clamping neck of the portable power tool or can be clamped axially against the housing of a portable power tool by means of a bayonet connecting device. Such a connection of attachment and portable power tool is known, for example, from DE 10 2007 006 329 A1.

### SUMMARY

An object of the disclosure can be considered to be that of extending the range of application of portable power tools and of in particular providing an attachment which makes it easier for screws to be screwed in.

The object is achieved by the subject matter of the present disclosure. Further embodiments are described in the present disclosure.

It may be considered necessary to provide the user with attachments for his portable power tool which utilize the portable power tool merely as a drive unit for attachments, the attachments being suitable for special functions which are not used so frequently as a rule.

For example, portable power tools can be used for screwing preferably spax countersunk screws into wooden structural parts without these wooden structural parts being predrilled. However, the power of such portable power tools is usually not sufficient to screw the abovementioned screw into the wooden structural part until the head of the screw terminates flush with the surface of the wooden structural part or is set back relative to this surface.

According to an exemplary embodiment of the disclosure, an attachment for a portable power tool has an output shaft having a tool receptacle for accommodating an application tool, a locking unit which can be releasably attached to a housing of the portable power tool, and an input shaft which can be connected to a drive shaft of the portable power tool in a rotationally fixed manner. In this case, the attachment has a torque converter for converting a first torque which acts on the input shaft into a second torque which acts on the output shaft.

Standard applications can be dealt with using the portable power tool without an attachment. The advantage consists in the fact that the portable power tool itself can be kept small and light for standard applications and is provided with an additional attachment only when required in order to thereby extend the range of application by a torque conversion. To take the abovementioned example, using the portable power tool which has no attachment and the drive shaft of which is connected to an application tool, for example a PoZidriv bit, in a rotationally fixed manner, the spax countersunk screw, for example, can be screwed into the wooden structural part, which has not been predrilled, until the torque applied to the application tool is no longer sufficient to screw the screw further into the wooden structural part. Through the use of an attachment which increases the torque and is connected to the drive shaft of the portable power tool in a rotationally fixed manner, the screw can now be screwed further into the wooden structural part. Therefore the use of the torque converter enables the aim to be achieved, namely to cause the head of the spax screw to terminate flush with the surface of the wooden structural part or to also screw it even further into the wooden structural part.

As a rule, the increase in the torque is accompanied by a reduction in the speed. It is of course also possible to conceive the torque converter in such a way that the torque applied to the input shaft of the attachment by the drive shaft of the portable power tool is available with reduced magnitude and accordingly the speed at the output shaft is increased relative to the speed at the input shaft.

According to a further exemplary embodiment of the disclosure, the torque converter of the attachment is designed for optionally converting the first torque into one of a plurality of second torques.

The attachment therefore need not necessarily have only one predetermined torque ratio between the input shaft and the output shaft. On the contrary, by an appropriate configuration, the first torque can be converted into any desired second torque. In this case, the second torque can be greater than, equal to or less than the first torque.

According to a further exemplary embodiment of the disclosure, the torque converter is a transmission.

The transmission can be configured, for example, as a gear train. As a rule, the gears have equispaced teeth on their outer circumference, said teeth being connected to both the input shaft and the output shaft in a rotationally fixed manner. These gears are in mesh with one another, such that a rotation of the input shaft automatically also brings about a rotation of the output shaft. The torque conversion is produced by the number of teeth of the gear connected to the input shaft being different from the number of teeth of the gear connected to the output shaft. In such an arrangement, the axis extending in the longitudinal extension direction of the input shaft is usually at a distance from or offset from the axis extending in the longitudinal extension direction of the output shaft. In this arrangement, too, without further design measures, the direction of rotation of the output shaft is opposed to the direction of rotation of the input shaft.

According to a further exemplary embodiment of the disclosure, the transmission can be operated in transmission stages.

There is therefore a fixed graduation of the torques acting on the output shaft relative to the torque acting on the input shaft, wherein the second torque applied to the output shaft can be freely selected within the predetermined stages relative to the first torque applied to the input shaft.

According to a further exemplary embodiment of the disclosure, the second torque is greater than the first torque in a first transmission stage of the attachment, and the first torque and the second torque are equal in a second transmission stage.

Following the example of use described above, the attachment can now be coupled to the portable power tool before the spax countersunk screw, for example, is screwed into the wooden structural part. The screwing operation therefore need not be interrupted in order to couple the attachment to the portable power tool and thus achieve a higher torque. This advantageous configuration of the attachment therefore makes it possible to couple the attachment to the portable power tool, insert the application tool into the tool receptacle provided on the output shaft and screw the countersunk screw rapidly in the second transmission stage into the wooden structural part until the torque applied to the screw is no longer sufficient in order to screw the screw further into said wooden structural part. The second torque is now increased relative to the first torque by simply switching over from the second transmission stage to the first transmission stage. The screw can now be screwed further into the wooden structural part by this increased torque, even though with a reduced speed compared with the second transmission stage.

According to a further exemplary embodiment of the disclosure, the input shaft and the output shaft are arranged coaxially to one another.

This results in ergonomic handling qualities of the portable power tool with coupled attachment, since, between the original orientation of the tool receptacle of the portable power tool, there is neither an offset transverse to the longitudinal extension direction of the portable power tool nor an angular change relative to the orientation of the tool receptacle of the attachment. On the contrary, the attachment coupled to the portable power tool can even be used in order to guide the portable-power-tool attachment combination more effectively using a second hand, namely by the second hand grasping the attachment.

In this arrangement, a first center axis running in a longitudinal extension direction of the input shaft is in alignment with a second center axis running in a longitudinal extension direction of the output shaft, and this second center axis of the output shaft is also in alignment with a third center axis running in a longitudinal extension direction of the drive shaft of the portable power tool. If a gear train which is operated with externally toothed gears is used, the input shaft, which is not connected to the output shaft, can be driven by means of an intermediate shaft, wherein a fourth center axis running in a longitudinal extension direction of the intermediate shaft runs parallel to the first and the second center axes, but is offset from these two center axes. A first gear connected to the input shaft in a rotationally fixed manner can be thrown into mesh with a second gear connected to the intermediate shaft in a rotationally fixed manner. A third gear can be connected to the intermediate shaft in a rotationally fixed manner, said third gear being in mesh with a fourth gear connected to the output shaft in a rotationally fixed manner. The second torque applied to the output shaft can be varied relative to the first torque applied to the input shaft by appropriate selection of the number of teeth of the externally toothed gears, in particular selection of the number of teeth of the second and the third gears.

According to a further exemplary embodiment of the disclosure, the transmission of the attachment is an epicyclic transmission.

As a rule, an epicyclic transmission is conceived in such a way that the input shaft and the output shaft are arranged coaxially to one another.

According to a further exemplary embodiment of the disclosure, the epicyclic transmission of the attachment has a sun gear having a first external tooth system, at least one planet having a second external tooth system, a planet carrier connected to the at least one planet, and a ring gear having a first internal tooth system. In this case, the first external tooth system of the sun gear is in mesh with the second external tooth system of the at least one planet, and the second external tooth system of the at least one planet is in mesh with the first internal tooth system of the ring gear. Furthermore, the input shaft is connected to the sun gear in a rotationally fixed manner and the output shaft is connected to the planet carrier in a rotationally fixed manner.

Furthermore, the planets are mounted so as to be freely rotatable relative to the planet carrier. As a rule, an uneven number of planets are used, thus three or five in the present case. This can ensure that meshing of the same teeth does not take place until after a relatively long time interval. If the same teeth were always to be in mesh in short time intervals, a possible tooth defect on one of the gears could damage the tooth with which it always comes into mesh even in a relatively short time. As a rule, such tooth damage leads to noise generation. This can be amplified even further by the housing, which possibly acts like an acoustic body, such that the user of the machine finds this noise annoying.

According to a further exemplary embodiment of the disclosure, the planet carrier of the attachment has, at least in one section, a third external tooth system connected to the planet carrier in a rotationally fixed manner. In this case, in the second transmission stage, the first internal tooth system of the ring gear is in mesh both with the third external tooth system of the planet carrier and with the second external tooth system of the planet.

In the second transmission stage, therefore, the rotatability of the at least one planet relative to the planet carrier is blocked by the ring gear. The ring gear, the at least one planet and the planet carrier form a unit which is not rotatable in itself and which is brought into rotationally fixed connection with the sun gear. Therefore the sun gear can no longer move relative to the unit. This now means that a first speed of the sun gear, or of the input shaft or of the drive shaft of the portable power tool, is identical to a second speed of the unit, or to the speed of the output shaft connected to the planet carrier in a rotationally fixed manner. Since the first speed is therefore identical to the second speed, the first torque and the second torque are therefore also identical, while disregarding any friction losses or other effects.

According to a further exemplary embodiment of the disclosure, the attachment has a housing which has, at least in one section, a second internal tooth system connected to the housing in a rotationally fixed manner. The ring gear has, at least in one section, a fourth external tooth system connected to the ring gear in a rotationally fixed manner. In the first transmission stage, the fourth external tooth system is in mesh with the first internal tooth system in such a way that the ring gear cannot rotate relative to the housing.

As a rule, the fourth external tooth system and the second internal tooth system are provided circumferentially; however, just one tooth is sufficient in order to ensure a rotationally fixed connection between housing and ring gear. A rotationally fixed connection can also be produced, for example, by a form fit. One example of this which may be mentioned is a circle having a flat or an ellipse when viewing the outer contour of the ring gear in a cross section as a positive geometrical shape, the housing then having the corresponding negative geometrical shape.

The at least one planet is also rotationally driven by a rotation of the sun gear at a first speed. Said planet, since it is firmly in mesh with the ring gear, additionally orbits the sun gear at a second speed, which is lower than the first speed. This second speed is at the same time also the speed of the planet carrier and thus also of the output shaft. The ratio of the first speed to the second speed is obtained from the number of teeth of the sun gear to the number of teeth of the ring gear. Reduction ratios of up to 1:12 can normally be achieved with a transmission stage.

According to a further exemplary embodiment of the disclosure, the sun gear, the at least one planet and the ring gear in the attachment are produced from a metallic material.

For example, brass, bronze, steel and its alloys are suitable here. It is not necessary in this case for all the gears, including the ring gear, to be produced from the same material. Thus, for example, the sun gear can be produced from a ferrous alloy, the planets can be produced from brass and the ring gear can be produced from bronze. The sun gear and/or the at least one planet and/or the ring gear can also be produced from a nonmetallic material. Plastics, in particular glass-fiber reinforced or carbon fiber reinforced plastics are suitable for this purpose. The materials are as a rule selected in such a way that the teeth of the individual gears can absorb high tooth loading and are subject to low wear.

According to a further exemplary embodiment of the disclosure, a portable power tool has an attachment for converting a torque.

### BRIEF DESCRIPTION OF THE DRAWINGS

FIG. 1 shows a side view of an embodiment of an attachment with a fitted application tool and a locking unit, and

FIG. 2 shows an illustration of a section through the attachment according to FIG. 1 along an input shaft and an output shaft.

### DETAILED DESCRIPTION

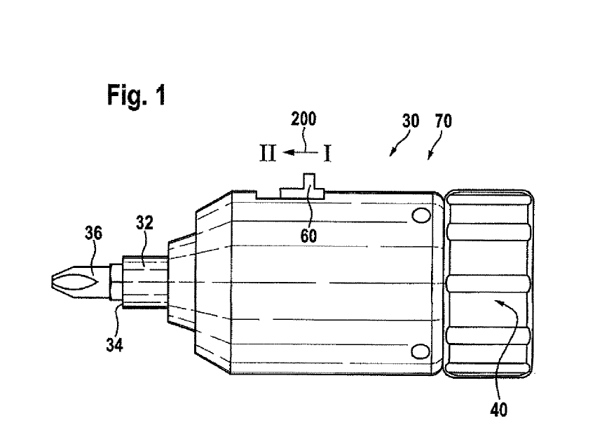

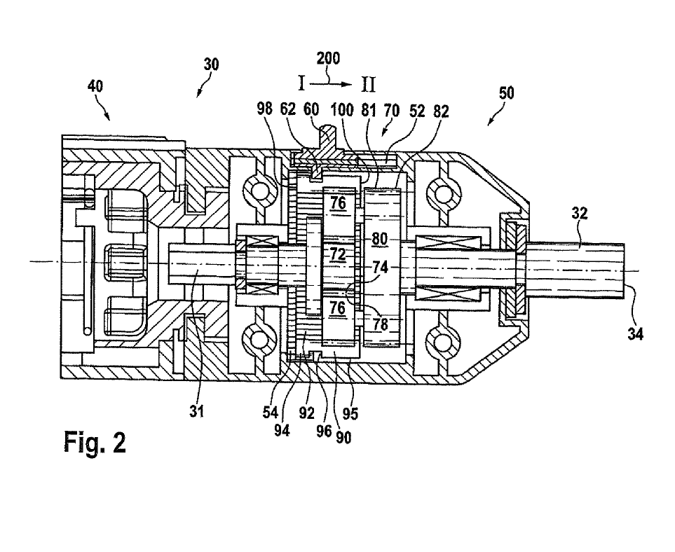

FIG. 1 shows a side view of an embodiment of an attachment 30 for a portable power tool with a fitted application tool 36 and a locking unit 40 which can be releasably attached to a housing of the portable power tool. Furthermore, the attachment 30 comprises an output shaft 32 having a tool receptacle 34 for accommodating the application tool 36. In the present embodiment, the application tool 36 is designed as a Phillips screwdriver bit. Not shown in this figure is an input shaft 31, which, however, can be seen in FIG. 2 and which can be connected to a drive shaft of the portable power tool in a rotationally fixed manner. The attachment 30 constitutes a torque converter 70 which is set up for converting a first torque which acts on the input shaft 31 into a second torque which acts on the output shaft 32. Furthermore, a transmission stage switch 60 can be seen in FIG. 1, and this transmission stage switch 60 is located in position I and can be shifted by manual displacement in the direction of arrow 200 into position II.

FIG. 2 shows an illustration of a section through the attachment 30 according to FIG. 1 along the input shaft 31 and the output shaft 32. At an end of the input shaft 31 opposite the locking unit 40, a sun gear 72 is fixedly connected to this input shaft 31. The sun gear 72 has, over the entire circumference thereof, a first external tooth system 74 which is fixedly connected to the sun gear. The first external tooth system 74 of the sun gear 72 is in mesh with a second external tooth system 78 of four planets 76, of which only two are shown here. The second external tooth system 78 of the planets 76 is in mesh with a first internal tooth system 92 of a first ring gear 90. A groove 96 is arranged circumferentially on an outer side 95 opposite the first internal tooth system 92 of the ring gear 90. In the exemplary embodiment shown here, the groove 96 is a “rectangular groove”. Furthermore, the ring gear 90 has a fourth external tooth system 94 on a section of its outer side 95 between the groove 96 and a front side 98 facing the locking unit 40. This fourth external tooth system 94 therefore extends only between the front side 98 and the groove 96, but not between the groove 96 and a rear side 100, facing the output shaft 32, of the ring gear 90. The fourth external tooth system 94 extends over the entire circumference of the ring gear 90 and is fixedly connected to the ring gear 90. In contrast thereto, the first internal tooth system 92 already referred to is continuous between the front side 98 and the rear side 100 of the ring gear 90. For production reasons, however, the entire outer side 95 of the ring gear 90 can be provided with the fourth external tooth system 94.

The planets 76 are rotatably connected to a planet carrier 80. On its outer side 81, the planet carrier 80 has a third external tooth system 82. The output shaft 32 having the tool receptacle 34 is fixedly connected to the planet carrier 80. Furthermore, it can be seen that a rail-shaped receptacle 52 is formed in a housing 50 in which said epicyclic transmission is arranged. The transmission stage switch 60 already known from FIG. 1 is arranged in the receptacle 52 so as to be rotationally fixed and longitudinally displaceable relative to the housing 50. Fixedly connected to the transmission stage switch 60 is an extension 62, which in turn is in engagement with the groove 96 of the ring gear 90. Furthermore, a second internal tooth system 54 is arranged in the housing 50. This internal tooth system 54 is fixedly connected to the housing 50.

Shown in FIG. 1 is an epicyclic transmission which has two transmission stages, i.e. a first transmission stage I and a second transmission stage II. In order to reach the second transmission stage II from the first transmission stage I, the switch 60 is moved along the receptacle 52 in the housing 50 in the direction of arrow 200 into the position II. In FIG. 2, therefore, the first transmission stage I is shown, wherein the torque acting on the output shaft 32 is higher than that acting on the input shaft 31. Epicyclic transmissions are ideal for producing reduction ratios within the range of 1:1 to 1:12 by means of a transmission stage. A reduction ratio of 1:4 is preferably produced in the exemplary embodiment selected here.

The functioning of the transmission is to be explained with reference to FIG. 2. With its extension 62 engaging in the groove 96 of the ring gear 90, the transmission stage switch 60 located in position I has pushed the ring gear 90 in the direction of the locking unit 40 until the fourth external tooth system 94 of the ring gear 90 is in mesh with the second internal tooth system 54 of the housing 50. Rotation of the ring gear 90 relative to the housing 50 is therefore prevented. The ring gear 90 is designed in such a way that it is not in mesh with the third external tooth system 82 of the planet carrier 80 in this transmission position I. The planet carrier 80 can therefore rotate relative to the ring gear 90. The rotating input shaft 31 rotates the sun gear 72 at a first speed. The rotating sun gear 72 rotates the planets 76, the second external tooth system 78 of which is in mesh both with the first external tooth system of the sun gear 72 and with the first internal tooth system 92 of the ring gear 90. The planets 76 therefore orbit the sun gear 72 at a second speed. Since the planets 76 are rotatably connected to the planet carrier 80, the second speed with which the planets 76 orbit the sun gear 72 is also at the same time the speed at which the planet carrier 80, or the output shaft 32, rotates. As already explained above, the second speed of the output shaft 32 is approximately one quarter of the first speed of the input shaft 31. Accordingly, the second torque applied to the output shaft 32 is quadrupled relative to the first torque applied to the input shaft 31.

In order to work with a transmission ratio of 1:1, that is to say that the first torque applied to the input shaft 31 is substantially as high as the second torque applied to the output shaft 32, the transmission stage switch 60 is shifted from the position I into the position II in the direction of arrow 200. As a result, the ring gear 92 is moved by means of the extension 62 in engagement with the groove 96 in the direction of the output shaft 32 to such an extent that the fourth external tooth system 94 of the ring gear 90 is no longer in mesh with the second internal tooth system 54 of the housing 50. In this position II, the ring gear 90 can therefore freely rotate relative to the housing 50. Furthermore, in this position II, the first internal tooth system 92 of the ring gear 90 is in mesh with both the second external tooth system 78 of the planets 76 and the third external tooth system 82 of the planet carrier 80. In this position II, therefore, the ring gear 90 prevents a rotation of the planets 76 relative to the planet carrier 80. In this position II, the planet carrier 80, the planets 76 and the ring gear 90 therefore form a unit in which the individual gears cannot rotate relative to one another. This unit is in mesh with the sun gear 72. Consequently, as a function of the speed of the sun gear 72, the unit will now be driven at the same speed. This means that the first speed at which the input shaft 31 is rotationally driven is identical to the second speed at which the output shaft is rotated.

If a portable power tool having an attachment 30 as has been described above is used for screwing, for example, spax countersunk screws into wooden structural parts that have possibly not been predrilled, the attachment 30 can be coupled to the portable power tool beforehand. By means of a suitable application tool 36, the screw is screwed in transmission stage II into the wooden structural part until the resistance has become so great that the second torque applied to the output shaft 32 is no longer sufficient to screw the screw into the wooden structural part. The transmission stage switch 60 is now shifted, if possible when the machine is stopped, from the transmission stage position II into the transmission stage position I in order to increase the second torque applied to the output shaft 32. The portable power tool is then switched on again and stepped down in speed, but increased in torque, and said screw is screwed further into the wooden structural part. As a rule, the screw is screwed into the wooden structural part until the screw head terminates flush with the surface of the wooden structural part or is set back relative to the surface.

It can therefore be considered to be advantageous to keep the portable power tool small and light for standard applications and to provide it with an attachment only for special applications, said attachment converting the torque, as in the present case. Although such an attachment makes the portable power tool heavier, the range of use of the portable power tool is increased.

What is claimed is:

1. An attachment for a portable power tool, comprising:
an output shaft having a tool receptacle configured to receive an application tool;
a locking unit configured to releasably attach to a first housing of the portable power tool;
an input shaft configured to be connected to a drive shaft of the portable power tool in a rotationally fixed manner; and
a torque converter configured to convert a first torque which acts on the input shaft into a second torque which acts on the output shaft.

2. An attachment according to claim 1, wherein the torque converter is configured to convert the first torque into any one of a plurality of second torques.

3. An attachment according to claim 1, wherein the torque converter is a transmission.

4. An attachment according to claim 3, wherein the transmission is configured to be operated in any one of a first transmission stage and a second transmission stage.

5. An attachment according to claim 4, wherein:
the second torque is greater than the first torque in the first transmission stage; and
the first torque and the second torque are equal in the second transmission stage.

6. An attachment according to claim 1, wherein the input shaft and the output shaft are arranged coaxially with respect to one another.

7. An attachment according to claim 3, wherein the transmission is an epicyclic transmission.

8. An attachment according to claim 7, wherein:
the epicyclic transmission has a sun gear having a first external tooth system, at least one planet having a second external tooth system, a planet carrier connected to the at least one planet, and a ring gear having a first internal tooth system,
the first external tooth system of the sun gear is in mesh with the second external tooth system of the at least one planet, and the second external tooth system of the at least one planet is in mesh with the first internal tooth system of the ring gear, and
the input shaft is connected to the sun gear in a rotationally fixed manner and the output shaft is connected to the planet carrier in a rotationally fixed manner.

9. An attachment according to claim 8, wherein:
the transmission is configured to be operated in any one of a first transmission stage and a second transmission stage,
the planet carrier has, at least in one section, a third external tooth system connected to the planet carrier in a rotationally fixed manner, and
in the second transmission stage, the first internal tooth system of the ring gear is in mesh both with the third external tooth system of the planet carrier and with the second external tooth system of the planet.

10. An attachment according to claim 9, further comprising a second housing which has, at least in one section, a second internal tooth system, wherein:
the ring gear has, at least in one section, a fourth external tooth system connected to the ring gear in a rotationally fixed manner, and
in the first transmission stage, the fourth external tooth system is in mesh with the first internal tooth system so that that the ring gear is prevented from rotating relative to the second housing.

11. An attachment according to claim 10, wherein the sun gear, the at least one planet, and the ring gear are produced from a metallic material.

12. A portable power tool assembly, comprising:
a portable power tool having a first housing and a drive shaft; and
an attachment including:
an output shaft having a tool receptacle,
a locking unit releasably attached to the first housing of the portable power tool,
an input shaft connected to the drive shaft of the portable power tool in a rotationally fixed manner, and
a torque converter configured to convert a first torque which acts on the input shaft into a second torque which acts on the output shaft.

13. The portable power tool assembly of claim 12, further comprising an application tool received in the tool receptacle.

14. The portable power tool assembly of claim 13, wherein:
the application tool includes a screw driver bit having a proximal drive portion and a distal drive portion, and
the proximal drive portion is positioned in the tool receptacle.

15. The portable power tool assembly according to claim 12, wherein the torque converter is configured to convert the first torque into any one of a plurality of second torques.

16. The portable power tool assembly according to claim 12, wherein:
the torque converter is a transmission,
the transmission is configured to be operated in any one of a first transmission stage and a second transmission stage,
the second torque is greater than the first torque in the first transmission stage; and
the first torque and the second torque are equal in the second transmission stage.

17. The portable power tool assembly according to claim 12, wherein the input shaft and the output shaft are arranged coaxially with respect to one another.

18. The portable power tool assembly according to claim 16, wherein:
the transmission is an epicyclic transmission,
the epicyclic transmission has a sun gear having a first external tooth system, at least one planet having a second external tooth system, a planet carrier connected to the at least one planet, and a ring gear having a first internal tooth system,
the first external tooth system of the sun gear is in mesh with the second external tooth system of the at least one planet, and the second external tooth system of the at least one planet is in mesh with the first internal tooth system of the ring gear, and
the input shaft is connected to the sun gear in a rotationally fixed manner and the output shaft is connected to the planet carrier in a rotationally fixed manner.

19. The portable power tool assembly according to claim 18, wherein:
the planet carrier has, at least in one section, a third external tooth system connected to the planet carrier in a rotationally fixed manner, and
in the second transmission stage, the first internal tooth system of the ring gear is in mesh both with the third external tooth system of the planet carrier and with the second external tooth system of the planet.

20. The portable power tool assembly according to claim 19, wherein:
the attachment further includes a second housing,
the second housing has, at least in one section, a second internal tooth system,
the ring gear has, at least in one section, a fourth external tooth system connected to the ring gear in a rotationally fixed manner, and
in the first transmission stage, the fourth external tooth system is in mesh with the first internal tooth system so that that the ring gear is prevented from rotating relative to the second housing.
